(19) United States
(12) Patent Application Publication
(10) Pub. No.: US 2014/0290487 A1
(43) Pub. Date: Oct. 2, 2014

(54) DEVICE AND METHOD FOR FILTERING UNTREATED AIR, BEVERAGE BOTTLING AND/OR BEVERAGE CONTAINER PRODUCTION SYSTEM AND USE OF AT LEAST ONE PRESSURE DIFFERENTIAL VALUE MEASURED BY MEANS OF A PRESSURE AT ONE FILTER ELEMENT OF FILTER ELEMENTS THAT ARE CONNECTED IN SERIES

(71) Applicants: Franz Braun, Bad Abbach (DE); Juergen Soellner, Beratzhausen (DE); Josef Doblinger, Reichenbach (DE)

(72) Inventors: Franz Braun, Bad Abbach (DE); Juergen Soellner, Beratzhausen (DE); Josef Doblinger, Reichenbach (DE)

(73) Assignee: KRONES AG, Neutraubling (DE)

(21) Appl. No.: 14/128,210

(22) PCT Filed: Jun. 28, 2012
(86) PCT No.: PCT/EP2012/062625

§ 371 Date: Mar. 21, 2014

(30) Foreign Application Priority Data
Jul. 7, 2011 (DE) 10 2011 107 401.9

(51) Int. Cl. B01D 46/44; G01L 19/00

(52) U.S. Cl. CPC B01D 46/446; G01L 19/00
USPC 95/287; 53/235; 53/558; 96/421; 73/717

(57) ABSTRACT

A device for filtering untreated air in an air supply of a clean room of a beverage treatment system, having more than one filter element and a pressure differential measuring assembly, in which the filter elements are connected to the pressure differential measuring assembly for pressure measurement such that a respective first pressure pick-up is arranged upstream of the respective filter element and a second pressure pick-up.

The invention relates to an apparatus for filtering untreated air in an air supply of a clean room of a beverage treatment plant with more than one filter element and with a differential pressure measurement arrangement, in which the filter elements are attached to the differential pressure measurement arrangement by means of pressure measurement in such a way that a first pressure reduction means is attached upstream of the respective filter element and a second pressure reduction means is attached downstream of the respective filter element in each case, each of the filter elements being capable of being monitored by means of a differential pressure with respect to its functionality.

In addition, the invention relates to a method of filtering untreated air in an air supply of a clean room of a beverage treatment plant, in which at least degrees of contamination of the filter elements are determined by means of measured differential pressures for monitoring filter elements connected in series and in which at least one pressure value is detected upstream of one of the filter elements and at least one further pressure value is detected downstream of this filter element.

Furthermore, the invention relates to a beverage filling plant and/or a beverage container production plant.

Also the invention relates to a use of at least one differential pressure value measured by means of pressure at one filter element of filter elements connected in series.

Variously high demands are made upon the environmental purity in particular in the beverages industry depending upon the product to be filled. In the case of non-critical products for example a filling into beverage containers can be carried out at a filling location with a normal degree of environmental purity without additional measures to improve hygiene. In the case of higher demands upon the environmental purity it is possible in particular for a suitable filling plant to be enclosed and for the filling to be carried out in a clean room under the protection of the enclosure, in which case for example elements for filtering the supplied air can be positioned on a roof of the clean room. As a result of the filtered air in particular in the region of the filling plant a more superior environment in terms of hygiene can be created than outside the clean room. It is preferable for the filtered air supplied to the clean room to flow through existing openings only exclusively from the interior of the clean room into the environment outside the clean room on account of an over-pressure prevailing in the clean room. An air exchange existing in this way ensures that different classes of clean room can be formulated. In the event of the hygiene demands being further increased the filling plant can be made available in the design of an isolator in which the entire path of the bottles is separated hermetically from the external air. On account of a suitable supply of filtered air and preferably an additional air suction a defined air flow can be guaranteed, so that the filling can be carried out under the most hygienic conditions.

In the case of the possibilities of use described, the filtered air can be supplied either decentrally by means of a plurality of suitable designed FFUs (filter fan units) or by means of a single central FFU. In each case, however, the air to be supplied is always filtered through a plurality of filter elements of usually different filter classes arranged or connected respectively one behind the other.

In order to monitor the filters, in particular in order to determine a critical degree of contamination on one of the filter elements, an air pressure differential capable of being allocated to each filter element is determined on the basis of an air pressure on an untreated side upstream of the respective filter element and on the basis of a further air pressure on a clean side downstream of the corresponding filter element as viewed in the direction of the air flow. When the air pressure differential reaches a critical value it is time to replace the filter element.

For the measurement of the air pressure differential necessary for this, use can be made for example of pressure measurement instruments in accordance with the differential pressure measurement arrangement on a filter fitting monitoring means shown in the European Patent Application EP 1 143 232 A1.

A filter fitting monitoring means with a differential pressure measurement arrangement for determining a differential pressure in a line system for a fluid with an untreated side and a clean side is known from the European Patent Application EP 1 143 232 A1, in which the untreated side is separated from the clean side in a sealed manner by a filter element, in which a first pressure recording unit is arranged on the untreated side and a second pressure recording unit is arranged on the clean side, in which case the first pressure recording unit on the untreated side is connected in a suitable manner to the second pressure recording unit on the clean side. In addition, the filter fitting monitoring means is characterized by an evaluation unit or respectively a corresponding pressure measurement instrument for the detection of differential pressures which are lower than a minimum reference pressure value, the minimum reference pressure value being higher than the differential pressure prevailing at a new correctly fitted and functional filter element. The differential pressure measurement arrangement designed in this way provides a filter fitting monitoring means of structurally simple and, in addition, operationally reliable design.

It is easy to see that in particular in the case of a plurality of filter elements arranged one behind the other—especially in the case of a plurality of FFUs arranged decentrally as is frequently the case with relatively large beverage treatment plants—correspondingly many differential pressure measurement arrangements, in particular pressure measurement instruments, are used in order to be able to monitor each individual filter element. It is additionally easy to see that as the number of pressure measurement instruments increases the probability of failure as a whole also rises, as a result of which a repair outlay in particular and a maintenance outlay in general are increased. In addition, the plurality of pressure measurement instruments also need a correspondingly large installation space requirement and the many pressure measurement instruments also result in considerable acquisition costs.

In order to be able to reduce the monitoring outlay in the case of a plurality of FFUs, it is already known to combine the FFUs to form a section and in this case to monitor only one filter element per class of filters inside this section in each case. As a result, the number of the pressure measurement instruments required can be reduced in an advantageous manner, since it is assumed that the filter elements of one class of filters are subject to an approximately similar progression of contamination and therefore also need to be replaced at the same time. In this way, only one filter element per class of filters needs to be monitored in the respective section by means of a suitable pressure measurement instrument. This carries the risk, however, that critical degrees of contamination may remain undiscovered on the filter elements not monitored, as a result of which in particular the quality of the hygiene capable of being achieved can be adversely affected in an undesired manner.

The object of the invention is to make available a method in order to be able to implement a clean room filter element monitoring means in particular on a treatment plant for beverage containers in relatively inexpensive manner, without in this case running the risk of a deterioration in quality with respect to the quality of the clean air.

The object of the invention is attained by an apparatus for filtering untreated air in an air supply of a clean room of a beverage treatment plant with more than one filter element and with a differential pressure measurement arrangement, in which the filter elements are attached to the differential pressure measurement arrangement by means of pressure measurement in such a way that a first pressure reduction means is attached upstream of the respective filter element and a second pressure reduction means is attached downstream of the respective filter element in each case, each of the filter elements being capable of being monitored by means of a differential pressure with respect to its functionality, and the filter apparatus being characterized in that the differential pressure measurement arrangement has fewer differential pressure measurement devices than filter elements to be monitored on the differential pressure measurement arrangement are attached by means of pressure measurement.

As a result, according to the invention a plurality of filter elements can actually be monitored, and not only monitored by way of example, with a sharply reduced number of differential pressure measurement devices with respect to contamination, as is the case with FFUs combined in one section, as a result of which the operational reliability with respect to a clean air supply can be substantially increased as compared with the prior art. This is crucially advantageous in particular in the beverage industry since a completely filled beverage container charge can rapidly become unusable in the event that prescribed hygiene requirements are not observed.

In the sense of the invention the term “beverage treatment plant” embraces not only a beverage filling plant but, in addition, all plants in the beverage industry which in view of hygiene requirements comprise a clean room, i.e. for example also a plant for the stretch blow moulding of beverage containers.

In the present case the differential pressure measurement arrangement comprises all the devices for a reduction in pressure for example on an air supply to a corresponding clean room.

The term “air supply” essentially describes in this case an air conveying duct in which the filter elements are arranged one behind the other, i.e. connected in series, as viewed in the direction of flow. It is preferable for the air supply to comprise a filter fan unit (FFU) so that not only filter elements are arranged in the air conveying duct but in addition also at least one fan device in the air conveying duct.

In the sense of the invention the term “pressure reduction” means any device by means of which access to an air supply or to an air conveying duct respectively is capable of being implemented in order to ascertain the respective pressure conditions.

The concept “differential pressure measurement device” describes in the sense of the invention a pressure measurement instrument by means of which a differential pressure can be measured from pressures detected upstream of a filter element and downstream of a filter element.

A particularly preferred variant of embodiment provides that at least two filter elements or the filter elements attached to the differential pressure measurement arrangement and to be monitored respectively are allocated to a single differential pressure measurement device by means of pressure measurement.

As a result, a plurality of filter elements can actually be measured in an advantageous manner with respect to contamination with only one differential pressure measurement device, as a result of which an enormous reduction in costs can be achieved.

If for example acquisition costs of the order of from [symbol] 150 to [symbol] 700 are taken as a basis depending upon the design of a differential pressure measurement device and if approximately 15 necessary differential pressure measurement devices are assumed on average per filter apparatus or per plant respectively, the potential saving in costs which is capable of being achieved is easy to see. It is clear that further not inconsiderable potential savings with respect to maintenance and repair costs will follow.

A structurally preferred variant of embodiment provides that the filter elements are connected in series, preferably in a filter fan unit (FFU).

The object of the invention is also attained by a method of filtering untreated air in an air supply of a clean room of a beverage treatment plant, in which at least degrees of contamination of the filter elements are determined by means of measured differential pressures for monitoring filter elements connected in series and in which at least one first pressure value is detected upstream of one of the filter elements and at least one further pressure value is detected downstream of this filter element, the filtering method being characterized in that at least one differential pressure with respect to at least one of the filter elements connected in series is determined with reference to further differential pressures measured on the filter elements connected in series.

As a result of determining at least one differential pressure of one of the filter elements without measuring a differential pressure in this respect on the filter element, not only the structural monitoring outlay but also the monitoring outlay with respect to the method are substantially reduced on a corresponding filter apparatus in an advantageous manner.

In this respect the object of the invention is also attained by the use of at least one differential pressure value measured by means of pressure at one filter element of filter elements connected in series for determining at least one further differential pressure of a further filter element of the filter elements connected in series.

In the present case a degree of contamination can be ascertained in an advantageous manner by, in particular, merely calculating a differential pressure with respect to a filter element. It is preferable for two differential pressures previously measured by means of pressure on two filter elements to be used as the basis of the calculation for this.

It is also possible for differential pressures not measured to be determined by means of a comparison table in which corresponding reference differential pressure values are stored or kept respectively.

In this respect, a further advantageous variant of embodiment provides a suitable determination device which can be assisted for example by suitable hardware and/or software.

If pressure values are detected in each case on at least two filter elements connected in series upstream and downstream of the filter elements, in which case only two pressure values—to be compared—of the pressure values detected are always set by means of pressure at a single differential pressure measurement device of a differential pressure measurement arrangement, it is possible in an advantageous manner to dispense with further differential pressure measurement devices which would otherwise be required.

In order to be able to connect—if necessary—pressure reduction means provided in a suitable manner on an air supply to the existing differential pressure measurement device by means of pressure, it is advantageous for the differential pressure measurement arrangement to have shut-off valves which are capable of being controlled in terms of time and which are arranged between the filter elements to be monitored and the differential pressure measurement device. It is advantageous in this case for the number of the shut-off valves to be at least equal to the number of the filter elements and preferably larger than the number of the filter elements. Depending upon requirements, however, the number of the shut-off valves can also be smaller than the number of the filter elements.

In this respect it is advantageous for the filter apparatus to have a control device by means of which the shut-off valves are capable of being controlled.

The degree of contamination of the filter elements can be monitored periodically in an advantageous manner, as a result of which the filter apparatus or differential pressure measurement arrangement respectively of very simple design in the present case is particularly outstanding.

The risk of unfiltered air being able to pass through the differential pressure measurement device “bypass” into the clean room can also be prevented in an advantageous manner in that a differential pressure measurement is started on a second of the filter elements connected in series, preferably on the last of the filter elements connected in series, as viewed in the air flow direction, namely with the detection of the pressure value upstream of the filter element in question, as is explained in still greater detail by way of example with reference to one of the following embodiments.

The object of the invention is also attained in particular by a beverage filling plant and/or a beverage container production plant which is characterized by a filter apparatus according to any one of the features described here.

In the present case the individual pressures are made available advantageously in a clock-timed manner with respect to the filter elements of the differential pressure measurement device to be monitored, so that a single differential pressure measurement device is sufficient to be able to monitor all the filters in a suitable and operationally reliable manner.

In the present case, although the individual filter elements are no longer monitored continuously, since a degree of contamination on a filter element steadily increases in the course of time, however, it is sufficient for a periodic monitoring of the degree of contamination to be carried out in an advantageous manner.

The number of the filter elements to be monitored or of the pressure losses in this respect or of differential pressures respectively can be increased virtually in any desired manner.

For the reasons specified above the invention is particularly suitable for advantageous use in a beverage container treatment plant, as embodied in particular by a beverage filling plant or a beverage container production plant.

It is possible for the present concept also to be capable of being used for other types of sensor and cases of application when continuous measurement is not required.

Further advantages, aims and properties of the present invention are explained with reference to the accompanying drawing and the following description, in which apparatus designed in structurally different ways for the filtration of untreated air are illustrated and described by way of example. In the drawing

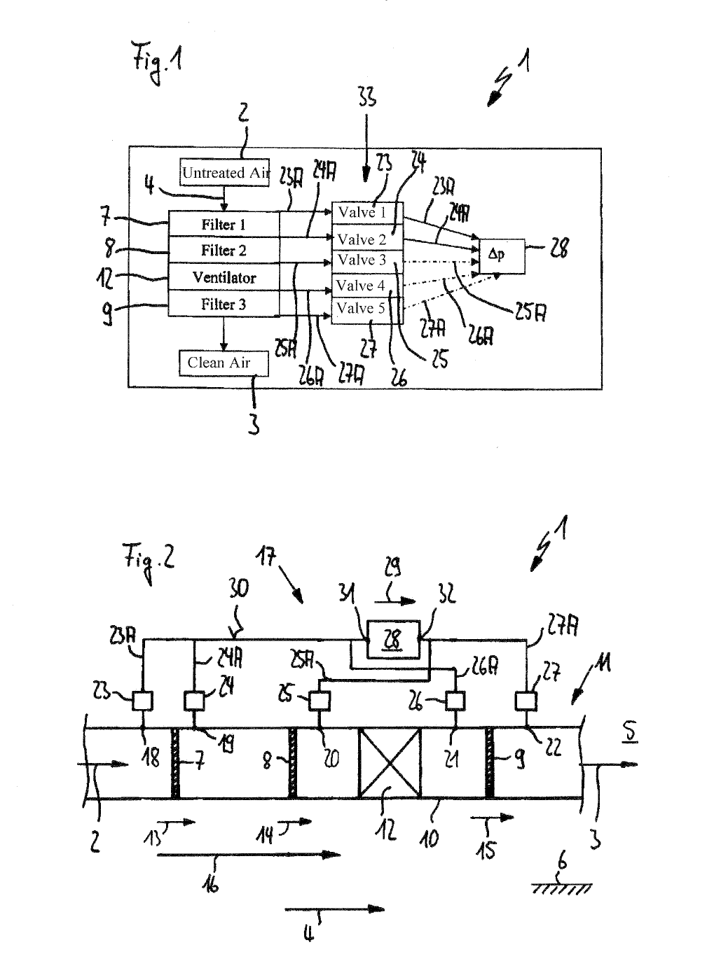

FIG. 1 is a diagrammatic view of a first filter apparatus for a clean room with a filter fan unit (FFU) comprising a plurality of filter elements connected in series as well as a fan and with a pressure measurement arrangement comprising a plurality of shut-off valves and a single differential pressure measurement instrument;

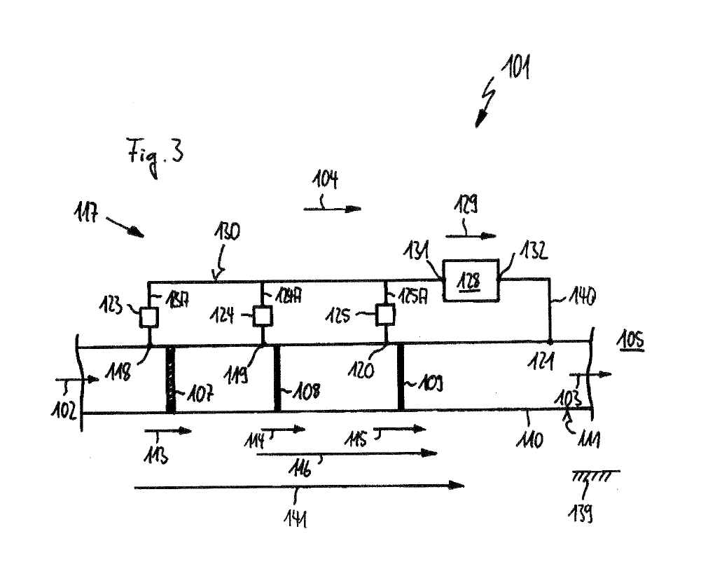

FIG. 2 is a diagrammatic view of a structural implementation of the filter apparatus as shown in FIG. 1, and

FIG. 3 is a diagrammatic view of a further filter apparatus for a clean room without an additional fan.

The apparatus 1 shown in FIGS. 1 and 2 for the filtration of untreated air 2 to form clean air 3, which is conveyed into a clean room 5 of a beverage filling plant 6 with a flow direction 4, comprises in this embodiment three filter elements 7, 8 and 9 which are arranged connected in series one behind the other in an air duct 10 of an air supply 11.

A fan 12 is arranged between the filter elements 8 and 9 in order to be able to compensate the pressure losses 13, 14 and 15 caused directly by the filter elements 7, 8 and 9 in each case in the air duct 10.

The pressure losses 13, 14 and 15 increase with the degree of contamination of the respective filter element 7, 8 and 9 respectively to be monitored, so that conclusions can be drawn in a known manner on the respective degree of contamination of the filter elements 7, 8 and 9 respectively by means of the measured magnitude of the respective direct pressure loss 13, 14 and 15 respectively.

In order to measure in particular the pressure losses 13, 14, 15 and also, however, a value of a further pressure loss 16, the filter apparatus 1 comprises a differential pressure measurement arrangement 17 which is attached to the air duct 10 of the air supply 11 by means of pressure by means of a plurality of pressure reduction devices 18, 19, 20, 21 and 22.

In addition, the differential pressure measurement arrangement 17 has five shut-off valves 23, 24, 25, 26 and 27 and according to the invention only a single differential pressure measurement instrument 28 for the measurement of the respective differential pressure 29 at the differential pressure measurement arrangement 17.

In this case the pressure reduction devices 18 to 22, the shut-off valves 23 to 27 and the differential pressure measurement instrument 28 are connected to one another by means of pressure by means of a suitable compressed air line system 30.

In order to measure the respective differential pressure 29 the differential pressure measurement instrument 28 has a pressure input side 31 and a pressure output side 32 in a known manner. In this respect the present measurement principle is known with respect to the differential pressure measurement.

What is novel with respect to the prior art is that the pressure reduction devices 18 to 22 can be connected in a clocked manner either to the pressure input side 31 or to the pressure output side 32 of the single differential pressure measurement instrument 28 by means of pressure by means of the shut-off valves 23 to 27 in a suitable manner.

As a result, a complete differential pressure measurement of all the pressure losses or differential pressures 13, 14, 15 and 16 respectively which occur in the air duct 10 is possible.

To this end the first pressure reduction device 18 is arranged on the air duct 10 upstream of the first filter element 7 and it is capable of being connected to the pressure input side 31 of the differential pressure measurement instrument 28 by means of pressure by means of the shut-off valve 23.

The second pressure reduction device 19 is attached to the air duct 10 downstream of the first filter element 7 and upstream of the second filter element 8 and is likewise capable of being connected by means of pressure to the pressure input side 31 of the differential pressure measurement instrument 28. To this end, use is made of the second shut-off valve 24.

The fourth pressure reduction device 21, which is arranged upstream of the third filter element 9, is also attached to the pressure input side 31. In this case the fourth pressure reduction device 21 is situated downstream of the fan 12 and it can be separated by means of pressure from the pressure input point 31 by means of the fourth shut-off valve 26 or it can be connected to it.

The third pressure reduction device 20 and the fifth pressure reduction device 22, on the other hand, are attached to the pressure output side 32 of the differential pressure instrument 28, in which case the third shut-off valve 25 is connected between the third pressure reduction device 20 and the pressure output side 32 and the fifth shut-off valve 27 is connected between the fifth pressure reduction device 22 and the pressure output side 32.

In this respect each of the pressure reduction devices 18 to 22 can be connected as desired in an advantageous manner to the differential pressure measurement instrument 28 or can be separated from it, depending upon the pressure reduction devices 18 to 22 between which a pressure differential is to be measured.

As a result, the differential pressure measurement arrangement 17 in particular differs to a quite outstanding degree from generic arrangements known from the prior art.

As is indicated very clearly by way of example from the illustration in accordance with FIG. 1, the individual pressure reduction devices 18 to 22 can be brought together in a valve island 33 into which the individual shut-off valves 23 to 27 are combined, as a result of which a valve unit capable of being cleaned in a clear and easy manner is formed. A control device (not additionally shown) incorporated in the differential pressure measurement instrument 28 is provided in order to connect the individual shut-off valves 23 to 27.

In this case the shut-off valves 23 to 27 preferably capable of being actuated electrically always connect in a preferably time-controlled manner only two of the pressure reduction devices 18 to 22 to the corresponding pressure input side 32 or pressure output side 32 respectively, so that two pressures prevailing in the air duct 10 which are to be compared can be compared with each other by means of the single differential pressure measurement instrument 28.

The differential pressures 13 to 16 determined in this way can be made available for further evaluation on a machine control means (not shown here).

As is further evident in particular from the illustration of FIG. 2, the pressure losses 14 and 15 are measured directly with respect to the filter elements 8 and 9, i.e. the pressures of the valve lines 26A and 27A or 24A and 25A respectively are compared with each other in pairs.

The pressure loss 13 with respect to the filter element 7 is calculated on the other hand. To this end the pressure loss 16 is first measured in that the valve lines 23A and 25A are applied to the differential pressure measurement instrument 28. The value of the pressure loss 14 is deducted from the value of the pressure loss 16 and the value of the pressure loss 13 is obtained.

The pressure values either from the valve lines 23A, 24A or 26A are applied to the pressure input side 31. In the switch-over from the valve line 23A to the valve line 24A for the first time the air enclosed in the line portion (not numbered separately here) upstream of the pressure input side 31 can arrive in the space (not numbered separately here) of the air duct 10 connected downstream of the first filter element 7, without the air having passed through the first filter element 7 beforehand.

This air must then, however, pass the second filter element 8. This always ensures in an advantageous manner that no air arrives unfiltered in the clean room 5 through the “bypass” differential pressure arrangement 17. The risk can be entirely eliminated if a start is made with the pressure value with respect to the valve line 26A at the pressure input side 31 in a pressure measurement for the first time. When the valve line 23A is subsequently freed, a release takes place into the region upstream of the first filter element 7 and when the valve line 24A is freed, a release takes place into the space upstream of the second filter element 8.

The pressure either from the valve line 25A or from the valve line 27A is applied to the pressure output side 32 of the differential pressure measurement instrument 28, in which case the pressure from the valve line 27A is always higher on account of the fan 12 arranged between the two pressure reduction devices 20 and 22 than the pressure from the valve line 25A. In this way, in the event of a change from the valve line 25A to the valve line 27A the air is compressed until the pressure value of the valve line 27A is set. In the event of a change from the valve line 27A to the valve line 25A the air is released by the valve line 25A into the region (not numbered separately here) upstream of the third filter element 9, until the pressure value existing in the line portion (not numbered separately here) connected downstream of the pressure outlet side 32 prevails from the valve line 25A. The air “forced back” into the aforesaid region then flows through the third air filter element 9 and is only then supplied as filtered clean air 3 to the clean room.

The apparatus 101 for filtering shown in FIG. 3 has substantially a similar design as the filter apparatus 1 as shown in FIGS. 1 and 2. It is likewise characterized by a differential pressure measurement arrangement 117 which has only a single differential pressure measurement instrument 128 for measuring a corresponding differential pressure 129 in order to monitor all the filter elements 107, 108 and 109 by means of pressure with respect to degrees of contamination.

The filter elements 107, 108 and 109 are arranged connected in series in an air duct 110 of an air supply 111 of a clean room 105 of a beverage container production plant 139 and are traversed by untreated air 102 in the flow direction 104, so that clean air 103 flows into the clean room 105 downstream of the filter elements 107, 108 and 109.

In addition, however, the filter apparatus 101 has no fan 12, as a result of which only four pressure reduction devices 118, 119, 120 and 121 as well as three shut-off valves 123, 124 and 125 are provided.

A compressed air conveying system 130 of the differential pressure measurement arrangement 117 has in particular a valve line 123A, a valve line 124A, a valve line 125A and a pressure reduction line 140, which are all attached to a single differential pressure instrument 128. In this case the valve lines 123A, 124A and 125A are connected if necessary to a pressure input side 131 of the differential pressure measurement instrument 128. The pressure reduction line 140 is always connected to a pressure output side 132 of the differential pressure measurement instrument 128.

A pressure loss or a differential pressure 113 respectively with respect to the first filter element 107 is determined by a differential pressure 141 being measured by freeing the first valve line 123A on the pressure input side 131 and by a differential pressure 116 then being measured by freeing the second valve line 124A. It is to be understood that the individual shut-off valves 123, 124 and 125 are accordingly opened or closed respectively for this purpose. The differential pressure 113 is determined on the first filter element 107 by subtraction of the differential pressure 116 from the differential pressure 141.

A pressure loss or a differential pressure 114 respectively with respect to the second filter element 108 is determined by the differential pressure 116 being measured by freeing the second valve line 124A on the pressure input side 131 and by a differential pressure 115 then being measured by freeing the third valve line 125A. The differential pressure 114 is finally determined on the second filter element 108 by subtraction of the differential pressure 115 from the differential pressure 116.

In this respect all the degrees of contamination of the individual filter elements 107, 108 and 109 can be determined in a particularly simple manner structurally with only one differential pressure measurement instrument 128.

It is to be understood that as many filter elements as desired can be monitored in the present case.

In this case filter elements of the same sections can also be combined, as is already known.

It is also to be understood that the embodiments explained above are only arrangements of the filter apparatus according to the invention. In this respect the arrangement of the invention is not restricted to these embodiments.

The Applicants reserve the right to claim all the features disclosed in the application documents as being essential to the invention, insofar as they are novel either individually or in combination as compared with the prior art.

### LIST OF REFERENCES

1 apparatus for filtration
2 untreated air
3 clean air
4 direction of flow
5 clean room
6 beverage filling plant
7 first filter element
8 second filter element
9 third filter element
10 air duct
11 air supply
12 fan
13 first pressure loss or differential pressure respectively
14 second pressure loss or differential pressure respectively
15 third pressure loss or differential pressure respectively
16 fourth pressure loss or differential pressure respectively
17 differential pressure measurement arrangement
18 first pressure reduction device
19 second pressure reduction device
20 third pressure reduction device
21 fourth pressure reduction device
22 fifth pressure reduction device
23 first shut-off valve
23A valve line
24 second shut-off valve
24A valve line
25 third shut-off valve
25A valve line
26 fourth shut-off valve
26A valve line
27 fifth shut-off valve
27A valve line
28 single differential pressure measurement instrument
29 differential pressure
30 compressed air line system
31 pressure input side
32 pressure output side
33 valve island
101 apparatus for filtration
102 untreated air
103 clean air
104 direction of flow
105 clean room
107 first filter element
108 second filter element
109 third filter element
110 air duct
111 air supply
113 first pressure loss or differential pressure respectively
114 second pressure loss or differential pressure respectively
115 third pressure loss or differential pressure respectively
116 pressure loss or differential pressure respectively
117 differential pressure measurement arrangement
118 first pressure reduction device
119 second pressure reduction device
120 third pressure reduction device
121 fourth pressure reduction device
123 first shut-off valve
123A valve line
124 second shut-off valve
124A valve line
125 third shut-off valve
125A valve line
128 single differential pressure measurement instrument
129 differential pressure
130 compressed air conveying system
131 pressure input side
132 pressure output side
139 beverage container production plant
140 pressure reduction line
141 differential pressure

1-10. (canceled)

11. An apparatus for filtering untreated air in an air supply of a clean room of a beverage treatment plant having more than one filter element and with a differential pressure measurement arrangement, in which the filter elements are attached to the differential pressure measurement arrangement by pressure measurement in such a way that a first pressure reducer is attached upstream of the respective filter element and a second pressure reducer is attached downstream of the respective filter element in each case, wherein each of the filter elements is capable of being monitored by a differential pressure measurement device with respect to its functionality, wherein the differential pressure measurement arrangement has fewer differential pressure measurement devices than filter elements to be monitored on the differential pressure measurement arrangement attached by pressure measurement.

12. The filter apparatus according to claim 11, wherein at least two filter elements attached to the differential pressure measurement arrangement and to be monitored are allocated to a single differential pressure measurement device by pressure measurement.

13. The filter apparatus according to claim 11, wherein the differential pressure measurement arrangement has shut-off valves which are capable of being time-controlled and which are arranged between the filter elements to be monitored and the differential pressure measurement device by pressure measurement.

14. The filter apparatus according to claim 13, wherein the filter apparatus has a control device for controlling the shut-off valves.

15. The filter apparatus according to claim 11, wherein the filter elements are connected in series.

16. The filter apparatus according to claim 15, wherein the filter elements are connected in series in a filter fan unit.

17. A method of filtering untreated air in an air supply of a clean room of a beverage treatment plant, in which at least degrees of contamination of the filter elements are determined by measured differential pressures for monitoring filter elements connected in series and in which at least one first pressure value is detected upstream of one of the filter elements and at least one further pressure value is detected downstream of this filter element, wherein at least one differential pressure with respect to at least one of the filter elements connected in series is determined with reference to further differential pressures measured on the filter elements connected in series.

18. A method of filtering according to claim 17, wherein pressure values are detected in each case on at least two of the filter elements connected in series upstream and downstream of the filter element, wherein only two pressure values—to be compared—of the pressure values detected are always set by pressure at a single differential pressure measurement device of a differential pressure measurement arrangement.

19. A method of filtering according to claim 17, wherein the differential pressure measurement is started on a second of the filter elements connected in series, as viewed in the air flow direction, namely with the detection of the pressure value upstream of the filter element in question.

20. The method of filtering according to claim 19, wherein the differential pressure measurement is started on the last of the filter elements.

21. A beverage filling plant and/or a beverage container production plant, having a filter apparatus as claimed in claim 11.

22. A method for monitoring filters in a clean room of a beverage treatment plant, comprising using at least one differential pressure value measured by pressure at one filter element of filter elements connected in series for determining at least one further differential pressure of a further filter element of the filter elements connected in series.
